(19) United States
(12) Patent Application Publication
(10) Pub. No.: US 2021/0062977 A1
(43) Pub. Date: Mar. 4, 2021

(54) ODORANT PUMP

(71) Applicant: Welker, Inc., Sugar Land, TX (US)

(72) Inventor: Josh H. Welker, Richmond, TX (US)

(21) Appl. No.: 17/004,246

(22) Filed: Aug. 27, 2020

Related U.S. Application Data
(60) Provisional application No. 62/893,375, filed on Aug. 29, 2019.

(51) Int. Cl. F17D 3/12; C10L 3/00

(52) U.S. Cl. CPC F17D 3/12; C10L 3/006

(57) ABSTRACT

The present disclosure provides a unique pump for odorizing natural gas. The pump uses a bellows and a vanishing chamber technology (in combination with one another) to provide extremely precise and accurate, dependable and repeatable pumping technology. It does so while limiting the escape of odorant vapors to the atmosphere by keeping the bellows and the chamber physically separated from one another to reduce the need to access the chamber when performing maintenance on the pump.

### CROSS-REFERENCES TO RELATED APPLICATIONS

This application claims priority to U.S. Provisional Patent Application Ser. No. 62/893,375, filed on Aug. 29, 2019, entitled “ODORANT PUMP” currently pending, the entire disclosure of which is incorporated herein by reference

### FIELD OF THE INVENTION

The present invention relates generally to odorization of natural gas and more specifically to an improved system and method for adding odorant to natural gas flowing in a pipeline.

### BACKGROUND OF THE INVENTION

Natural gas is a clear, odorless, and tasteless gas when it is obtained from the ground. For safety purposes, odorant is commonly injected into natural gas before it is distributed to customers so that leaks are easily smelled.

There are many prior art odorant injection systems including U.S. Pat. No. 6,142,162 owned by the assignee of the present application, which is incorporated herein by reference. Other odorant injection systems are disclosed in U.S. Pat. Nos. 5,406,970 and 6,208,913 which are owned by Y-Z Industries, Inc.

Natural gas is odorless. Because of its potentially dangerous nature, for many years federal regulations have required the addition of an odorant to natural gas so that it can be detected by smell. Odorants such as tertiary butyl mercaptan (TBM) and various blends of commonly accepted chemicals are used in the industry.

The odorants added to natural gas, which are provided in liquid form, are often added to the gas at the location where distribution gas is taken from a main gas pipeline and provided to a distribution pipeline. At this point, the gas pressure is stepped down through a regulator, typically from a pressure of approximately 600 psi or more to a lower pressure of approximately 100 psi or less. The odorants can also be added to gas in the main transmission pipeline.

Odorants used with natural gas are extremely concentrated so that only a small amount of liquid is needed to odorize a relatively large volume of natural gas. For example, with odorants such as TBM and other blends, it is common to use approximately 0.75 lb. of liquid odorant to odorize 1,000,000 standard cubic feet (SCF) of natural gas.

Odorants such as TBM and other blends are mildly corrosive and very noxious. It is important that a correctly measured amount of odorant be added to natural gas; otherwise, various problems will result. For example, over-odorization results in excess odors within the valves, pipes, and other equipment used in natural gas distribution. In addition, too much odorant causes the distinctive odorant smell to be noticeable even after the natural gas is burned. This leads to consumer calls complaining of natural gas leaks, each of which must be responded to by the natural gas distribution company. The expense of such calls, when there is no leak involved, is quite high.

It is also important that the odorant levels not be too low. Safety considerations mandate that a natural gas leak be easily detectable by most people. The proper concentration of odorant within natural gas provides this safety measure, but under-odorization is dangerous because actual leaks may not be detected in time.

For pipelines with small volumes and/or slower flow rates, injecting very small volumes accurately is extremely difficult with typical odorant injection systems. Current pump-based injection systems are frequently used in applications at the extreme low end of their scalability, which compromises the systems' accuracy.

Independently, piston positive displacement pumps, or bellows pumps, have been used in the past. Piston pumps and bellows pumps cannot completely void the injection chamber, by design. Due to the seals involved and machining clearances, a 1.0 cc chamber cannot be completely voided 100%. The injection volume will instead always vary.

Other systems have had to take multiple strokes into a vessel and after completing a set number of strokes, take an average of the volume collected and then claim that the calculated volume was the injection rate per stroke. Over a long period of time, one may determine the total average injection volume, but not knowing each independent injection volume in a series of strokes could cause a lot of problems in a system that lead to imbalances. Such a system is left with inconsistencies and variable outputs.

It would be desirable to provide equipment that is simple and reliable in operation. It further should be flexible enough to easily accommodate significant changes in the operating condition of low volume gas systems and changes in consumer demand for natural gas.

### SUMMARY OF THE INVENTION

The present disclosure provides a unique pump for odorizing natural gas. Modern odorant injection systems are often controlled by a programmable logic controller (PLC), a personal computer (PC), a flow computer, or some combination thereof. There are a variety of methods to inject the odorant into the pipeline, and pumps are one of those methods. When working on pumps, one is in contact with the odorant and the smell is released to the atmosphere. In most cases this is not desirable to the surrounding populated areas. Those skilled in the art know that unwanted odorant vapors are troublesome. The improved pump system injects odorant and is repairable without odorant release and/or exposure, and it is designed to prevent the occurrence of a vapor lock, which many pumps on the market today cannot avoid.

The new inventive pump system utilizes bellows technology and a vanishing chamber technology (in combination with one another) to accomplish this style. The novel concept provides new, extremely precise and accurate, dependable and repeatable pumping technology while limiting the escape of odorant vapors to the atmosphere, if not eliminating odorant laden vapors altogether.

A new odorant pump is provided utilizing the vanishing chamber technology and bellows diaphragm technology combined in the same pump. Using a type of vanishing chamber (first described in U.S. Pat. No. 3,945,770) and bellows diaphragm technology, the pump can supply repeatable injection volumes of 100% of the vanishing chamber set volume (1.5 cc, 1.0 cc, 0.5 cc, 0.2 cc, etc.). Unlike the bellows function in the above-mentioned patent, the current technology is uniquely used in this pump to separate the main pump body and seal from the odorant itself during maintenance. For most maintenance issues with the pumping mechanism, the operator will not be exposed to the raw odorant. The bellows separates the injection area from the pumping mechanism.

The operator can know exactly what volume of odorant is injected on each and every stroke without having to wait for an averaging number. The vanishing chamber provides for consistent outlet volumes of fluid and thus helps eliminate inconsistencies of other styles of pumps. In small volume/low flow natural gas systems, this is critical. Over-supply or under-supply of odorant can raise alarms on the pipeline system.

The pump provides accurate injection rates for locations that are injecting small volumes into low flow pipelines or local distribution systems. A system can relay an exact injection volume of each stroke, in real time, to an operator. This may reduce or eliminate the inconsistent injection volumes seen in existing systems and provide greater reliability in the consistent performance of the injection process.

### BRIEF DESCRIPTION OF THE DRAWINGS

For a better understanding of the present invention, reference may be made to the following accompanying drawings.

FIG. 1 is an elevation view of an odorant pump constructed according to the teachings of the current application.

FIG. 2 is a cross-section view of the odorant pump of FIG. 1 taken across line 2-2.

FIG. 3 is an enlarged view of a portion of FIG. 2.

### DETAILED DESCRIPTION OF THE INVENTION

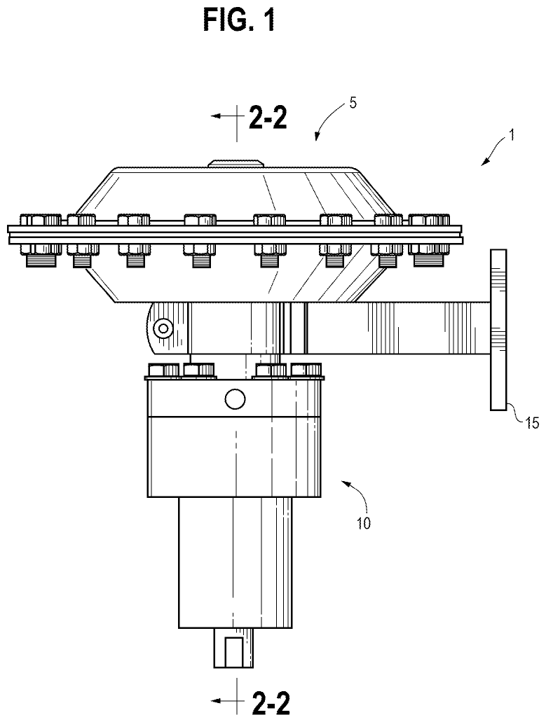

Turning first to FIG. 1, an odorant pump 1 is illustrated that may be used to pump odorant into a natural gas pipeline. In the embodiment illustrated in FIG. 1, the pump 1 includes each of a first end 5 and a second end 10. In operation, the first end 5 is nearer an actuation port that will be described in greater detail below, and the second end 10 may be nearer a pipeline into which the odorant may be injected when the pump 1 is operated. In the embodiment illustrated in FIG. 1, a mounting bracket 15 is also illustrated that may secure the pump 1 to a pipeline or other structure associated with a pipeline.

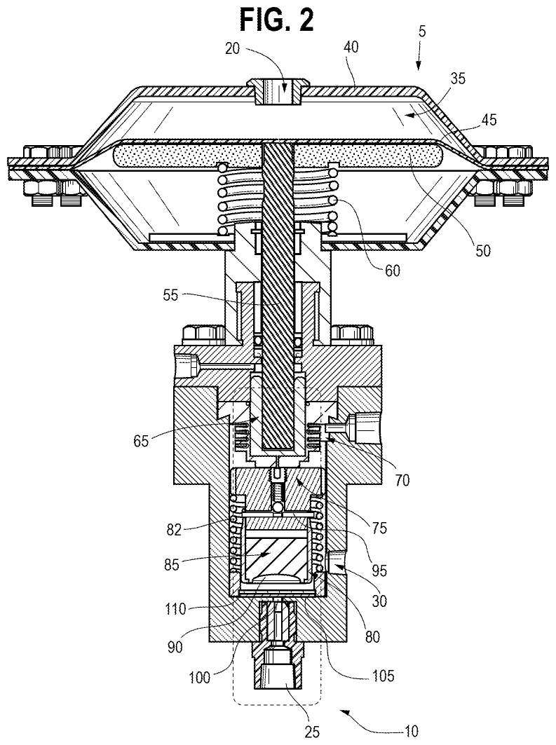

Turning to FIG. 2, at the first end 5, an actuation port 20 is illustrated through which instrument air may be introduced when a PLC or user may instruct a solenoid associated therewith to open and allow instrument air to be introduced to the port 20. In the embodiment illustrated in FIG. 2, the pump is in its unactuated state. However, as the various components that make up the pump 1 are described herein, the actions and movements of those components are described relative to each of their actuated and unactuated positions.

At the second end 10 of the pump 1, an odorant outlet 25 is provided from which odorant contained within the pump 1 may be expelled when instructed to do so. Odorant that is expelled from the odorant outlet 25 is introduced to the pump 1 via an odorant inlet 30 that is also positioned and located at the second end 10 of the pump 1.

To introduce odorant into a pipeline via the odorant outlet 25, an instruction is first provided to a solenoid (not illustrated) associated with the actuation port 20. The solenoid, when instructed to do so, may open such that instrument air upstream of the actuation port may be provided thereto.

After the instrument air is introduced into the actuation port 20, air may enter a chamber 35 positioned and located at the first end 5. The chamber 35 is defined on one side by an outer wall 40 of the pump 1 and at a second side by a diaphragm 45 that can expand and contract when air is introduced into the chamber 35. Adjacent to the diaphragm 45, and near the second end 10, a diaphragm plate 50 may also be provided. As air begins to fill the chamber 35, the diaphragm 45 and subsequently the diaphragm plate 50 may be moved toward the second end 10 by pressure that is built up by the air present in the chamber 35. In turn, a piston member 55 attached to the diaphragm plate 50, and in contact with the diaphragm 45, may also translate toward the second end 10. When air is not being introduced into the chamber 35, a spring member 60 that surrounds the piston member 55 may apply a biasing force to the diaphragm 45 via the diaphragm plate 50 in order to retain it in the position illustrated in FIG. 2.

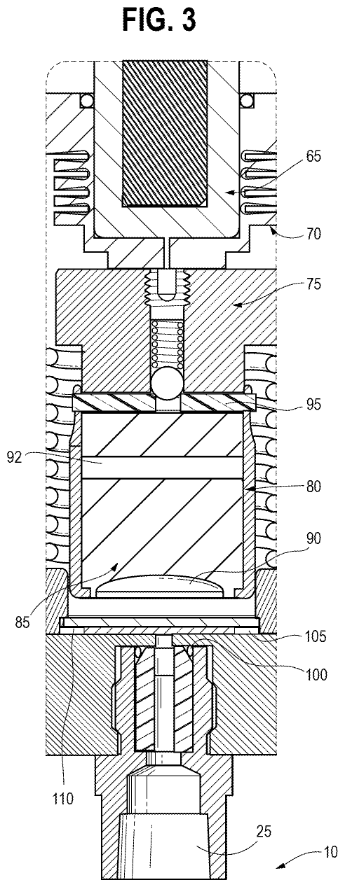

When the piston member 55 is acted upon by the air within the chamber 35, and it has translated toward the second end 10, it preferably also acts on a coupling member 65 (illustrated in a larger view in FIG. 3). The coupling member 65 preferably couples the piston member 55 to a bellows 70. As known and foreseeable to those skilled in the art, a bellows, such as the bellows 70, is able to expand and contract as a force is applied to it. In the position illustrated in FIG. 2, the bellows 70 is contracted, but when the coupling 65 is acted upon by the piston member 55, the bellows 70 may expand and act on a head member 75 that is further in communication with a cup chamber 80. A spring member 82 may surround the head member 75 and help to return it to its unactuated state after the pump has been actuated, as described below.

As illustrated in FIG. 2, the cup chamber 80 includes a cup member 85 (preferably formed from a rubber material) having a concave portion 90 in which odorant may enter via the odorant inlet 30 when the pump 1 is in its unactuated state illustrated in FIG. 2. The cup member 85 may be friction fit within the cup chamber 80 and may be provided in a wide range of sizes.

When the head member 75 acts on a wear disc 92 adjacent the cup chamber 80, the concave portion 90 of the cup member 85 may force outwardly and flex toward the odorant outlet 25 at the second side 10. Odorant contained in the concave portion 90 may then expel through a check valve 100 and out through the odorant outlet 25.

Because the volume of the concave portion 90 within the cup member 85 is known by an operator, the operator will know how much odorant is expelled via the odorant outlet 25 into the pipeline when a stroke is completed. Because the pump 1 is controlled by a PLC or operator, each such expulsion may be easily and consistently repeated to achieve appropriate odorant volumes to the pipeline.

Because of the construction of the pump 1, when a technician needs to service the pump 1, he or she need not access the odorant inlet 30, cup chamber 80 (including the concave portion 90 of the cup member 85), or the odorant outlet 25 unless, for example, the cup member 85 itself is in need of repair. All other repairs may be carried out without accessing the odorant. This can prevent unnecessary leaking of foul smelling odorant that not only is bothersome to a technician, but also may lead to the false sense that gas is leaking.

When a stroke is complete, seal members 105, 110 positioned and located between the check valve 100 and the concave portion 90 may release. They may do so, so that when the cup member 85 returns to its original position, vacuum force does not act strongly on the concave portion 90 when it returns to its concave shape. If not for the presence of the seal members 105, 110, such a vacuum force could cause damage to the various components described herein that ultimately expel odorant from the pump 1.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles, and scope of the present invention.

Many changes, modifications, variations, and other uses and applications of the present invention will, however, become apparent to those skilled in the art after considering the specification and the accompanying drawings. All such changes, modifications, variations, and other uses and applications which do not depart from the spirit and scope of the invention are deemed to be covered by the invention, which is limited only by the claims which follow.

1. A pump for introducing odorant into a pipeline, the pump including:
a bellows; and
a cup chamber in mechanical communication with the bellows; and
a cup member received in the cup chamber, the cup member including a concave portion in which odorant may be contained; and
wherein when the bellows acts on the cup chamber, the cup member acts on the concave portion to reduce concavity of the concave portion and eject odorant from the cup chamber and out of the pump.

2. The pump of claim 1, wherein a first end of the pump and the cup chamber are physically separated from one another such that the first end may be maintained or replaced without accessing the cup chamber.

3. The pump of claim 1, wherein the cup member is made from a rubber material that may return to form after each ejection.

4. The pump of claim 1, wherein the bellows is acted on by a coupling in mechanical connection with a piston member.

5. The pump of claim 4, wherein the piston member is in mechanical connection with a diaphragm.

6. The pump of claim 5, wherein a chamber is provided that is defined by the diaphragm and an outer wall of the pump, and wherein the chamber receives air from an actuation port when it receives instructions to do so, and the air in the chamber acts on the diaphragm to act on the piston member.

7. The pump of claim 1, wherein a PLC instructs the bellows to act on the cup chamber.

8. The pump of claim 1, wherein the cup member is friction fit in the cup chamber.

9. The pump of claim 1, wherein the odorant is introduced to the cup chamber via an odorant inlet and ejected from the cup member by a check valve.

10. The pump of claim 1, wherein at least one seal member is positioned and located adjacent to the cup member to release the cup member from a surface to which the concave portion of the cup member is adjacent when the odorant is injected.

11. A pump for introducing odorant into a pipeline, the pump including:
a bellows; and
a cup chamber in mechanical communication with the bellows but physically separated from the bellows; and
a cup member received in the cup chamber, the cup member including a concave portion in which odorant may be contained.

12. The pump of claim 11, wherein a first end of the pump and the cup chamber are physically separated from one another such that the first end may be maintained or replaced without accessing the cup chamber.

13. The pump of claim 11, wherein the cup member is made from a rubber material that may return to form after each ejection.

14. The pump of claim 11, wherein the bellows is acted on by a coupling in mechanical connection with a piston member.

15. The pump of claim 14, wherein the piston member is in mechanical connection with a diaphragm.

16. The pump of claim 15, wherein a chamber is provided that is defined by the diaphragm and an outer wall of the pump, and wherein the chamber receives air from an actuation port when it receives instructions to do so, and the air in the chamber acts on the diaphragm to act on the piston member.

17. The pump of claim 11, wherein a PLC instructs the bellows to act on the cup chamber.

18. The pump of claim 11, wherein the cup member is friction fit in the cup chamber.

19. The pump of claim 11, wherein when the bellows acts on the cup chamber, the cup member acts on the concave portion to reduce concavity of the concave portion and eject odorant from the cup chamber and out of the pump.

20. The pump of claim 11, wherein at least one seal member is positioned and located adjacent to the cup member to release the cup member from a surface to which the concave portion of the cup member is adjacent when the odorant is injected.
